(19) United States
(12) Patent Application Publication
(10) Pub. No.: US 2011/0319176 A1
(43) Pub. Date: Dec. 29, 2011

(54) DEVICE FOR THE VIBRATION-REDUCING TRANSMISSION OF TORQUES

(76) Inventor: Joachim Rothe, Muehldorf (DE)

(21) Appl. No.: 13/131,191

(22) PCT Filed: Nov. 26, 2009
(86) PCT No.: PCT/EP09/08438

§ 371 Date: Sep. 1, 2011

(30) Foreign Application Priority Data
Nov. 26, 2008 (DE) 102008059042.8
Nov. 26, 2008 (DE) 102008059043.6

(51) Int. Cl. F16D 3/70

(52) U.S. Cl. 464/71

(57) ABSTRACT

The present invention relates to a device for the vibration-reducing transmission of torques between two shaft sections in a shaft arrangement comprising two transmission parts that interact in a torque-transmitting manner in a coupling area, wherein each of the transmission parts has a protruding claw formation, which is received in a receiving area for the transmission of torque from the respectively other transmission part, wherein a damping device is provided between the transmission parts, wherein each of the transmission parts also has a closed bearing ring with a bearing opening, which receives and supports an axial positioning pin, and wherein the bearing ring is integrally connected to the associated claw formation of the respective transmission part and extends axially into the receiving area.

### TECHNICAL FIELD

The present invention relates to a device for the vibration-reduced transmission of torques between two shaft sections running along a longitudinal axis.

### BACKGROUND

Such devices are known from the prior art and are used, for example, to transmit torques in a steering column or in a drive train of a motor vehicle. Precisely in these applications it is necessary to use torque transmission devices which are constructed as compactly as possible on account of the ever-decreasing installation spaces and increasing torque requirements and which couple the shaft sections to one another with damping of torsional oscillations. In particular, such torque transmission devices are required to transmit the torques in as loss-free a manner as possible from one shaft section to the other shaft section, but sufficiently damp vibrations and torsional oscillations which occur, so as not to transmit, for example, structure-borne noise arising at the drive axle through the vehicle. For this reason, torque transmission devices are provided with damping elements which can compensate for such vibrations or torsional oscillations.

It is the object of the present invention to provide a device for the vibration-reduced transmission of torques of the type referred to at the outset which meets the increased requirements placed on the torque transmission with a compact construction.

### SUMMARY

This object is achieved by a device for the vibration-reduced transmission of torques between two shaft sections in a shaft arrangement comprising two transmission parts that interact in a torque-transmitting manner in a coupling area, wherein each of the transmission parts has a protruding claw formation, which is received in a receiving area for the transmission of torque from the respectively other transmission part, wherein a damping device is provided between the transmission parts, wherein each of the transmission parts also has a closed bearing ring with a bearing opening, which receives and supports an axial positioning pin, and wherein the bearing ring is integrally connected to the associated claw formation of the respective transmission part and extends axially into the receiving area. Owing to the use of transmission parts with claw formations protruding in the axial direction, it is possible to transmit even high torques between the shaft sections in a largely loss-free manner, while providing sufficient constructional possibilities for accommodating the vibration-reducing damping device. Furthermore, the transmission parts can each be supported or be mutually guided on a positioning pin, whereby undesired deflections or diffractions of the transmission parts relative to one another can be prevented in the entire rotational speed range and thus also at high centrifugal forces.

In order to achieve radial guidance of the two transmission parts over the entire length of the torque transmission device, a development of the invention provides that the claws of the claw formation of the one transmission part are received in corresponding receiving openings of the other transmission part. Thus, the claws of the claw formations of the one transmission part are received in the receiving openings, arranged around the closed bearing ring, of the respectively other transmission part, whereby the transmission parts are mutually guided and owing to the closed bearing rings a continuous support of the transmission parts on the positioning pin is possible. In other words, owing to the closed bearing rings and their bearing openings, the bearings are adapted to the length of the torque transmission device, whereby an inexpedient double-joint formations is avoided.

According to a preferred embodiment of the invention, it is provided that the shape of the radially inner section of the claw formation of the one transmission part is adapted to the shape of the closed bearing ring of the respectively other transmission part. In other words, the claws of the claw formation of the one transmission part are formed in such a way that they correspond to the shape of the bearing ring of the other transmission part, whereby mutual guidance of the transmission parts over the entire length of the torque transmission device is possible.

In order to achieve an as far as possible play-free and low-friction guidance of the two transmission parts, according to a preferred embodiment, between the bearing rings of the transmission parts there is provided on the positioning pin a positioning sleeve, and at the outer circumference of the torque transmission device between the transmission parts a slide bush is arranged. In the context of a play-free and low-friction support of the transmission parts by the bearing rings on the positioning pin it should be mentioned that the transmission parts are supported on the positioning pin by means of bearing bushes which are adapted to the length of the bearing rings. According to a preferred embodiment of the invention, the transmission parts are axially braceable by means of the positioning pin.

For the damping of torsional oscillations, a development of the invention provides that the damping device has at least two damping material coatings, in particular rubber coatings, in each case one damping material coating surrounding the claw formation and the receiving area of one of the transmission parts. These damping material coatings may have a progressive characteristic, i.e. on increasing pressing display decreasing damping behaviour with increasing rigidity.

In order to achieve as progressive a characteristic of the damping material coatings of the damping device as possible, a development of the invention provides that the claw formations and the receiving areas have indentations at their end running in the direction of the centre axis and that the damping material coating has a bulging thickening in the region of the indentations of the claws. The bulging thickenings of the damping material coatings in the region of the indentations act as an integrated predamper inside the compression-loaded damping device, i.e. in the region in which the claws are applied against the corresponding receiving openings in the event of loading. In other words, firstly the material coatings in the region of these thickenings are deformed, whereby a stepped damping behaviour of the damping device results.

According to a preferred embodiment of the invention, the claw formation of at least one of the transmission parts is at least partially covered with a first material, the vibration-reducing damping device between the claw formations of the two transmission parts being made of a second material. Owing to the use of transmission parts with claw formations protruding in the axial direction, it is possible to transmit even torques of large magnitude in a largely loss-free manner between the shaft sections. There are a variety of constructional possibilities here for accommodating a coating made of a first material on the metal components and a vibration-reducing damping device made of a second material. By applying a first material coating between the claw formations of the transmission parts and the vibration-reducing damping device made of a second material, possibilities of adapting the torque transmission device are obtained. In other words, the torque transmission device can be adapted by the first material coating to its area of application, i.e. drive train or steering column, and the particular type of vehicle or the rotational-speed and torque requirements.

Furthermore, a simply producible basic shape can be chosen for the claws made of metal. If the claw shape is to be specially configured for the torque transmission and the damping of torsional oscillations, this can be achieved more simply with the first material, e.g. plastic, covering the claws. Moreover, it is thus possible to avoid costly pretreatment of the metallic claw base body for subsequent vulcanising-on of rubber, since the rubber material is vulcanised onto the first material which constitutes the covering.

Thus, a preferred embodiment of the invention provides that the claw formations of the transmission parts are at least partially covered with plastic, in particular with a high-strength polyamide material, as the first material. The plastic which covers the claw formations of the transmission parts can be easily brought into a preferred shape for the torque transmission and for the mounting of the damping device made of a second material. In other words, for the basic shape of the claw formations made of metal, geometric shapes which are simple to produce are chosen and, specifically for the torque transmission and damping of torsional oscillations, advantageous formations of the claws are subsequently formed from plastic. The latter is injection-moulded directly onto the metal components and can be brought into the desired shape simply and inexpensively.

In this context, a particularly simple and inexpensively producible embodiment of the invention provides that the two transmission parts are substantially uniformly designed in the coupling area. The use of substantially identical transmission parts results in a less complicated and thus less expensive production of the device according to the invention.

With regard to the damping device, it is provided that the latter has a damping coating made of a second material, in particular rubber, between the claw formations of the transmission parts, which claw formations can be brought into engagement with one another and are covered with the first material. This damping coating may have a progressive characteristic, i.e. on increasing pressing display decreasing damping behaviour with increasing rigidity. A preferred embodiment of the invention provides that each of the claw formations of the transmission parts covered with the first material has in each case a damping material coating, in particular a rubber coating. In this context, it should further be mentioned that the at least one damping coating made of the second material may be further provided with additional insert parts, in particular made of plastic. Owing to these insert parts, the damping coating made of the second material is further stiffened, whereby a progressive damping characteristic is achieved. In other words, on increasing pressing, the insert parts move closer to the plastic coating covering the claw formation, whereby the rigidity of the torque transmission device rapidly increases at the end of the compression of the rubber coatings.

In order to achieve an as progressive a characteristic in the damping device as possible, a development of the invention provides that the coverings of the claw formations made of the first material have indentations at their end running in the direction of the centre axis and that the damping coating made of the second material has a bulging thickening in the region of the indentations of the covering of the claw formations made of the first material. The bulging thickenings of the damping material coating in the region of the indentations act as an integrated predamper inside the compression-loaded damping device. In other words, in the event of loading, firstly the material coatings in the region of these thickenings are substantially deformed, whereby a stepped damping behaviour of the damping device results.

According to the invention, it may further be provided that between the transmission parts there is provided a positioning pin, by means of which the device is axially braceable. The two transmission parts of the torque transmission device are supported on this positioning pin. Furthermore, between the transmission parts a central positioning sleeve may be arranged on the positioning pin.

For the radial play-free support of the transmission parts on the positioning pin, a preferred embodiment of the invention provides that each of the transmission parts has a closed bearing ring with a bearing opening, which receives and supports the axial positioning pin, wherein the bearing ring is integrally connected to the associated claw formation of the respective transmission part and extends axially into a receiving area of the transmission parts. In this connection, it should further be mentioned that the claws of the claw formation of the one transmission part are received in corresponding receiving openings in the receiving area of the respectively other transmission part. Owing to the closed bearing ring and the simultaneous reception of the claws of the claw formation of the one transmission part in the corresponding receiving openings of the other transmission part, guidance over the entire length of the torque transmission device is achieved, whereby undesired radial deflections or diffractions on account of the centrifugal force at high rotational speeds, e.g. in a drive train, can be avoided. In addition, owing to the bearing rings with the associated bearing openings, the bearings are adapted to the length of the torque transmission device, whereby inexpedient formation of double joints can be avoided.

The present invention further relates to a device for the vibration-reduced transmission of torques between two shaft sections in a shaft arrangement comprising two transmission parts that interact in a torque-transmitting manner in a coupling area, wherein each of the transmission parts has a receiving area, in which at least one protruding claw formations of an intermediate element engages for the transmission of torque, wherein a damping device is provided between the transmission parts and the intermediate element, wherein each of the transmission parts also has a closed bearing ring with a bearing opening, which receives and supports an axial positioning pin, and wherein the bearing ring is integrally connected to the associated claw formation of the respective transmission part and extends axially into the receiving area.

A development of the invention provides that the intermediate element has a disc-shaped base element, from which claw formations protrude on both sides in the axial direction.

According to the invention, the claw formation of the intermediate element is at least partially filled with an elastomer.

A preferred embodiment of the invention provides that the claws of the claw formation of the intermediate element are received in corresponding receiving openings in the receiving area of one of the transmission parts.

The invention further relates to a shaft arrangement having a device described above.

### BRIEF DESCRIPTION OF DRAWINGS

The invention is explained below by way of example with the aid of the accompanying figures, in which:

FIGS. 1A and 1B illustrate sectional views of a first embodiment of the invention;

FIGS. 2A and 2B illustrate sectional views of a second embodiment of the invention;

FIGS. 3A and 3B illustrate sectional views of a third embodiment of the invention;

FIGS. 4 and 5 illustrate perspective views of a fourth embodiment; and

FIGS. 6A and 6B illustrate sectional views of the fourth embodiment of the invention.

### DETAILED DESCRIPTION

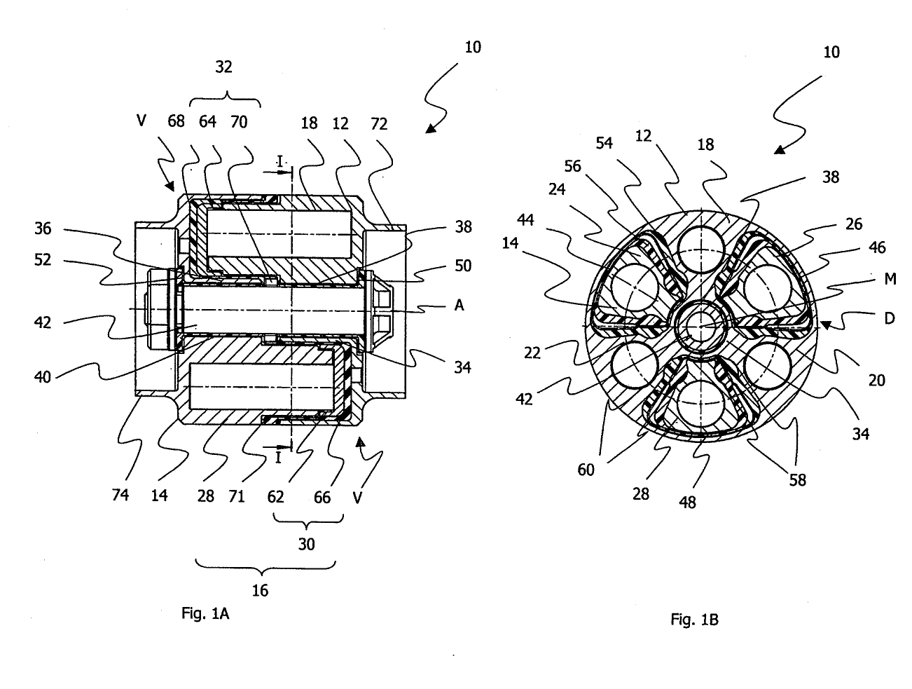

In FIGS. 1A and 1B a torque transmission device according to the invention is shown in each case in sectional views and denoted generally by 10. FIG. 1A shows an axis-containing longitudinal section along the longitudinal axis A, whereas FIG. 1B shows an axially orthogonal section through the arrangement along the section line I-I from FIG. 1A.

As can be seen in FIGS. 1A and 1B, the torque transmission device according to the invention has a first transmission part 12 and a second transmission part 14. The two transmission parts 12 and 14 overlap in a coupling area 16, said parts having in this coupling area 16 claw formations approximately circular sector-shaped in cross-section. The transmission part 12 has in total three claws 18, 20, 22 in each case offset by 120° with respect to one another. These claws 18, 20 and 22 project in the axial direction, as shown in FIG. 1A representatively for the claw 18. Similarly, the transmission part 14 has a corresponding claw formation 24, 26, 28, only the claw 28 being shown in FIG. 1A. The claw formation 24, 26 and 28 is, in the same way, arranged in an axially protruding manner on the second transmission part 14 and approximately circular sector-shaped in cross-section.

In FIG. 1A it can be seen that the transmission parts 12, 14 each have a receiving area 30, 32, in which the claw formation of the respectively other transmission part 12, 14 is received, in FIG. 1A only the claw 18 in the receiving area 32 of the transmission part 14 and correspondingly the claw 28 in the receiving area 30 of the transmission part 12. FIG. 1A additionally shows the bearing rings 34 and 36 of the transmission parts 12, 14, i.e. the bearing ring 34 of the transmission part 12 and the bearing ring 36 of the transmission part 14. The bearing rings 34, 36 each have a bearing opening 38 and 40, respectively, formed in them. In these bearing openings 38, 40 of the transmission parts 12, 14, an axial positioning pin 42 is received in a supporting manner. The bearing rings 38, 40 are integrally connected to the claw formation associated with them, in FIG. 1A again only to the claws 18, 28 shown, of the respective transmission part 12, 14 and extend, as can be seen in FIG. 1A, axially into the receiving areas 30, 32 of the transmission parts 12, 14.

It is thus also evident from FIG. 1A how deflections and diffractions of the transmission parts 12, 14 relative to one another can be avoided by the bearing rings 34, 36 and the bearing openings 38, 40, since there is mutual guidance between the claw formations 18, 20, 22 or 24, 26, 28 and the bearing rings 34, 36 extending into the receiving areas 30, 32, over the entire length of the torque transmission device. In other words, the claw formations 18, 20, 22 or 24, 26, 28 of the transmission parts 12, 14 are guided by the bearing rings 34, 36 in the receiving areas 30, 32. Owing to the bearing openings 38, 40 in the bearing rings 34, 36, a continuous support of the transmission parts 12, 14 on the positioning pin is achieved. A “continuous support” is to be understood in this context such that a formation of double joints is not possible and concomitant angular offsets between the transmission parts are effectively avoided.

In addition, FIG. 1B, which illustrates a sectional view along the section line I-I running through the receiving area 30 of the transmission part 12, shows how the claws 24, 26, 28 of the transmission part 14 are received in corresponding receiving openings 44, 46, 48 in the receiving area 30 of the transmission part 12. Owing to the bearing ring 34, the receiving openings 44, 46, 48 are closed off radially inwards, whereby only the bearing ring 34 with its bearing opening 38 is responsible for the support of the transmission part 12 on the positioning pin. At the same time, mutual guidance of the transmission parts 12, 14 with their claw formations 18, 20, 22 and 24, 26, 28 is achieved by the receiving openings 44, 46, 48 and the bearing ring 34, since no relative deflections of the transmission parts with respect to one another are possible on account of the reception of the claws 24, 26, 28 in the receiving openings 44, 46, 48 and of the bearing ring 34. The fact that the claws 24, 26, 28 are adapted to the shape of the receiving openings 44, 46, 48 and radially inwards to the shape of the bearing ring 34 also contributes to this guidance. At their radially inner end, the claws 24, 26, 28 therefore have cylindrical segment-shaped indentations which are adapted to the shape of the bearing ring 34 of the transmission part 12.

Thus, on the one hand, deflections of the transmission parts 12, 14 relative to one another can be avoided owing to the receiving openings 44, 46, 48 and the bearing rings 34, 36 closing off these receiving openings 44, 46, 48 and, on the other hand, double-joint formations and concomitant angular offsets between the transmission parts 12, 14 can be avoided owing to the bearings formed by the closed bearing rings 34, 36 and their bearing openings 38, 40, which bearings are adapted to the length of the torque transmission device 10.

In FIG. 1A there can further be seen bearing bushes 50, 52, by means of which the transmission parts 12 and 14 are supported on the positioning pin 42. The length of the bearing bushes 50, 52 is adapted to the length of the bearing rings 34, 36 associated with them. The bearing bushes 50, 52 contribute to an as far as possible frictionless support of the transmission parts 12, 14 on the positioning pin 42.

In the coupling area 16, the two transmission parts 12 and 14 are each covered with a rubber coating 54, 56. Specifically, a corresponding rubber coating 54 can be seen on the transmission part 12 and a corresponding rubber coating 56 can be seen on the claws 24, 26, 28 of the transmission part 14. The two rubber coatings 54 and 56 are vulcanised directly onto the lateral surfaces of the claw formations 18, 20, 22 and 24, 26, 28. The two corresponding rubber coatings constitute 54, 56 constitute a compression-loaded main damper device D.

It can further be seen in FIG. 1B that the claw formations 18, 20, 22 and 24, 26, 28 have indentations 58 at their end leading up to the centre axis M. Provided on the rubber coatings 54, 56 in the region of the indentations 58 are bulging thickenings 60 which fill the indentations 58 and project in the direction of the next claw of one of the claw formation 18, 20, 22 or 24, 26, 28 in the circumferential direction. The indentations 58 and the bulging thickenings 60 act as a predamper integrated into the compression-loaded damping device D.

Besides the compression-loaded damping device D, the torque transmission device 10 according to the invention further provides a torsion-loadable predamper device V. For the transmission of torques to the predamper device V, receiving dishes 62 and 64 which correspond to the claws 18, 28 and receive them in a form-fitting manner are provided. The number of receiving dishes 62, 64 corresponds to the number of claws of the claw formations 18, 20, 22 and 24, 26, 28, only the receiving dishes 62 and 64 are shown here representatively. The receiving dishes 62 and 64 are each connected to one of the transmission parts 12 and 14 by a rubber coating 66, 68, i.e. are vulcanised on.

Arranged between the transmission parts 12 and 14 or between their bearing rings 38, 40 is a central spacing and positioning sleeve 70 which is intended to enable an as far as possible low-friction and play-free support of the transmission parts 12 and 14 on the positioning pin. For the guidance of the transmission parts 12 and 14, a slide bush 71 is provided in their circumferential region.

The transmission parts 12 and 14 further have a tubular section 72 and 74 in their end regions. The torque transmission device 10 according to the invention can be connected to, for example welded or pressed onto, a shaft section via these tubular sections 72 and 74. However, other detachable connection possibilities are also conceivable, for example using a Hirth serration which can be formed on one of the transmission parts 12, 14 instead of the tubular section 72, 74.

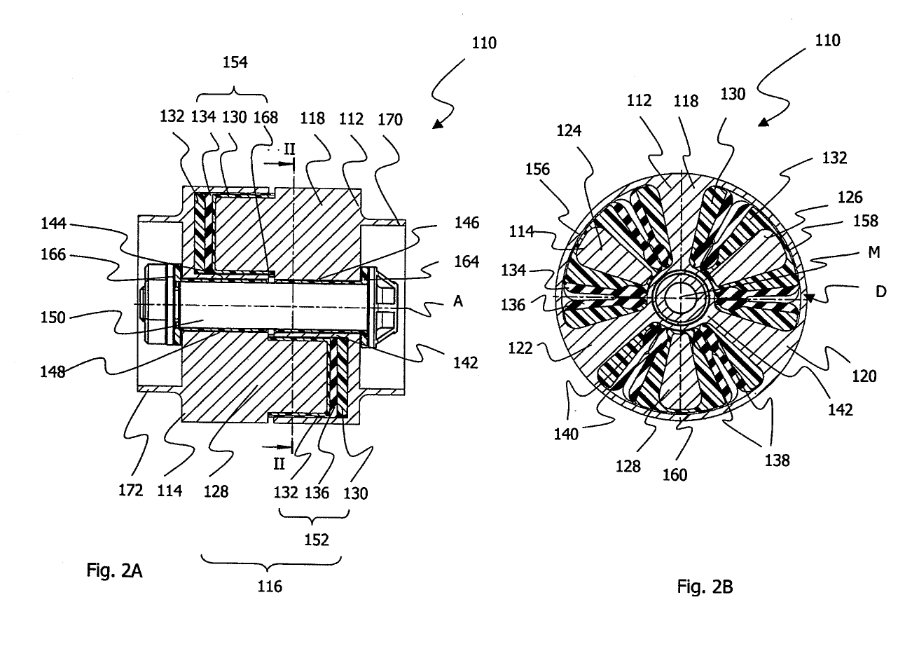

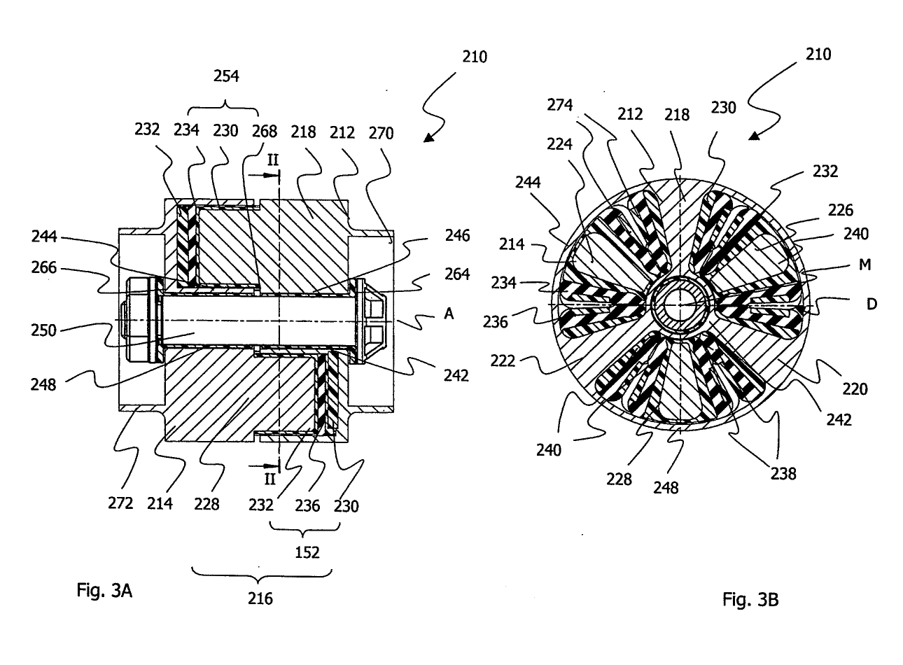

Further embodiments of the invention are explained below with reference to FIGS. 2A to 3B. To avoid repetition and to simplify the description, components acting in the same way or of the same kind use the same reference symbols as in the first exemplary embodiment, but preceded by a consecutive number.

In FIGS. 2A and 2B show sectional views of the torque transmission device 110. Thus, FIG. 2A shows an axis-containing longitudinal section along the longitudinal axis A, whereas FIG. 2B shows an axially orthogonal section through the arrangement. FIG. 2B has the section along the section line I-I from FIG. 2A.

As can be seen in FIGS. 2A and 2B, the torque transmission device according to the invention has a first transmission part 112 and a second transmission part 114. The two transmission parts 112 and 114 overlap in a coupling area 116, said parts having in this coupling area 116 claw formations approximately circular sector-shaped in cross-section. The transmission part 112 has in total three claws 118, 120, 122 in each case offset by 120° with respect to one another. This claw formation 118, 120 and 22 projects in the axial direction, as shown in FIG. 1 representatively for the claw 118. Similarly, the transmission part 114 has a corresponding claw formation 124, 126, 128, only the claw 128 being shown in FIG. 2A. The claw formation 124, 126 and 128 is, in the same way, arranged in an axially protruding manner on the second transmission part 114 and approximately circular sector-shaped in cross-section.

It can further be seen from FIGS. 2A and 2B that the claw formations 118, 120, 122 and 124, 126, 128 of the transmission parts 112 and 114 are covered with a coating of a first material 130 and 132. Specifically, there can be seen a corresponding material coating 130 of plastic on the transmission part 12 and a corresponding material coating 132 of plastic on the transmission part 114. The plastic is directly injection-moulded around the claws of the claw formations 118, 120, 122 and 124, 126, 128 to form the first material coatings 130, 132.

In this connection, it should be mentioned that besides the covering with plastic it is also possible to use other materials for covering the claw formations 118, 120, 122 and 124, 126, 128. Owing to these options regarding the choice of material, the torque transmission device 110 can be adapted to its different areas of application in the steering column or the drive train but also to different vehicle types with different requirements for the torque transmission. Thus, for example, the damping behaviour of the torque transmission device 110 can be influenced in a desired manner already by the first material coatings 130, 132.

FIGS. 2A and 2B additionally show that the claw formations 118, 120, 122 and 124, 126, 128 or their plastic coatings 130 and 132 are each covered with a rubber coating 134, 136 in the coupling area 116. Thus, the rubber coating 134 can be seen on the claw formation 118, 120, 122 of the transmission part 112 and a corresponding rubber coating 136 can be seen on the claw formation 124, 126, 128 of the transmission part 114. The two corresponding rubber coatings 134, 136 constitute a compression-loadable damping device D.

The coverings 130, 132 of plastic of the claw formations 118, 120, 122 and 124, 126, 128 have indentations 138 at their end leading up to the centre axis M. Provided on the rubber coatings 134, 136 in the region of the indentations 138 are bulging thickenings 140 which fill the indentations 138 and project in the direction of the next claws of a claw formation 118, 120, 122 or 124, 126, 128 in the circumferential direction. The indentations 138 and the bulging thickenings 140 act as a predamper integrated into the compression-loaded damping device D. In the event of loading, i.e. in the operation of the torque transmission device 110, firstly the material coatings in the region of the bulging thickenings 140 are deformed until a large-area contact of the coated claw formations occurs. This results in a stepped damping behaviour in the damping device D.

As can be clearly seen in particular from FIG. 2B, the claws of the claw formations 118, 120, 122 and 124, 126, 128 made of metal have a simple substantially regular shape which is simple to produce by various metal machining processes. The indentations 140, which are more difficult to produce, are integrally provided in the coatings 130, 132 of plastic. Since the material for the coatings 130, 132 is plastic, shapings of this kind, such as, for example, the indentations 138, can be simply produced during the injection-moulding around the claw formations 118, 120, 122 and 124, 126, 128. Furthermore, the plastic for the first material coatings 130, 132 can be chosen in such a way that the rubber coatings 134, 136 directly bond to the plastic without additional adhesion promoters being required, whereby the production costs can be reduced.

It can further be seen from FIGS. 2A and 2B that the transmission parts 112 and 114 each have a closed bearing ring 142 and 144 each with a bearing opening 146, 148 which receive an axial positioning pin 150 in a supporting manner, the bearing rings 142, 144 being integrally connected to the associated claw formation 118, 120, 122 or 124, 126, 128 of the respective transmission part 112 and 114 and extending axially into a receiving area 152 and 154 of the transmission parts 112 and 114. In addition, owing to the bearing rings 142, 144 with the associated bearing openings 146, 148, the bearings are adapted to the length of the torque transmission device 110, whereby inexpedient formation of double joints can be avoided and resulting angular offsets of the transmission parts 112, 114 can be prevented. Formed in the receiving areas 152 and 154 of the transmission parts 112 and 114 are in each case receiving openings 156, 158, 160 (FIG. 2B) for receiving the claw formations 118, 120, 122 or 124, 126, 128 covered with the first material coating 130, 132. Reference is made in this regard to FIG. 2B which shows a sectional view along the section line I-I running through the receiving area 152 of the transmission part 112.

In FIG. 2B the receiving openings 156, 158 and 160 in the receiving area 152 of the transmission part 112 can be seen. In addition, it is evident from FIG. 2B that the bearing ring 142 closes off the receiving openings 156, 158 and 160 radially inwards. Owing to the closed bearing rings 142, 144 of the transmission parts 112 and 114 and also the receiving openings 156, 158, 160, mutual guidance of the transmission parts 112 and 114 over the entire length of the torque transmission device 110 is achieved. The transmission parts 112 and 114 are supported on the positioning pin 150 in a manner low in friction and substantially free of radial play via the bearing openings 146, 148 of the closed bearing rings 142, 144 via bearing bushes 164, 166. In other words, owing to the closed bearing ring 134 and the simultaneous reception of the claws of the claw formation 124, 126, 128 of the transmission part 114 in the corresponding receiving openings 156, 158 and 160 of the transmission part 112, guidance over the entire length of torque transmission device 110 is achieved, whereby undesired deflections or diffractions on account of the centrifugal force at high rotational speeds, for example on use in a drive train, can be avoided.

Furthermore, between the closed bearing rings 142, 144 there is provided a central spacing and positioning sleeve 168 which is intended to enable an as far as possible axial play-free support of the transmission parts 112 and 114 on the positioning pin 150.

The transmission parts 112 and 114 have a tubular section 170, 172 in their end region. The torque transmission device 110 according to the invention can be connected to, for example welded or pressed onto, a shaft section via this tubular section 170, 172. However, other, detachable connection possibilities are also conceivable, for example using a Hirt serration which can be formed on the transmission part 112, 114 instead of the tubular section 170, 172.

A third exemplary embodiment of the invention is explained below with reference to FIGS. 3A and 3B (section II-II from FIG. 3A).

The essential difference from the first embodiment according to the invention lies in the fact that the damping material coatings 234, 236 which are applied to the first material coatings 230, 232 have insert parts 274. These insert parts are preferably produced from the same material as the material coatings 230, 232 covering the claw formations 218, 220, 222 or 224, 226, 228. Owing to the insert parts 274 of plastic, further stiffening of the damping rubber coatings 234, 236 or of the torque transmission device 210 can be achieved.

In the event of loading, the covered claws 218, 220, 222 and 224, 226, 228 are partially compression-loaded. During this compression loading, the insert parts 274 are applied against one another in the rubber coatings 234, 236 and owing to the increasing loading the rubber coatings 234, 236 are compressed. The insert parts 274 thus move closer to the plastic coatings 230, 232, whereby the rigidity of the damping device D greatly increases at the end of the compression and overall a progressive damping characteristic can be achieved.

It can further be seen in particular from FIG. 3B that the indentations 238 in the plastic coatings 230, 232 are not as pronounced as in the first exemplary embodiment. However, the bulging thickenings 240 reach as far as the insert parts 274.

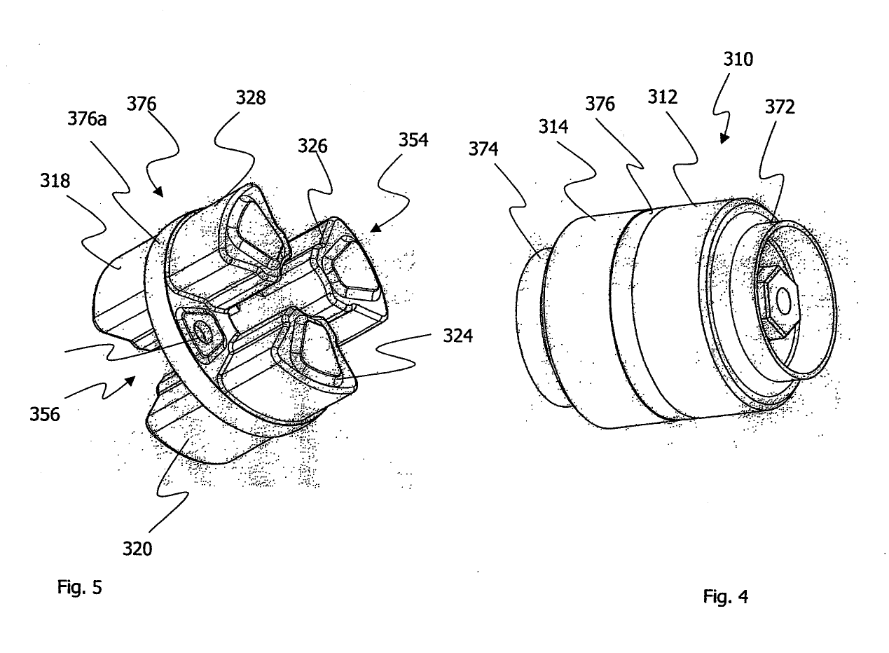

A fourth embodiment is described below with reference to FIGS. 4 and 5.

FIG. 4 shows a perspective view of the torque transmission device 310 according to a fourth embodiment of the invention. From FIG. 4 the two transmission parts 312 and 314 and also a section of an intermediate element 376 arranged between these transmission parts 312, 314 can be seen. FIG. 4 further shows the two tubular sections 372 and 374 on the transmission parts 312, 314, by which the transmission parts 312, 314 can be attached to shaft sections (not shown).

FIG. 5 shows a perspective view of the intermediate element 376 with the claw formations 318, 320 and 324, 326 and 328 protruding from a disc-shaped base element 376a.

In addition, it is shown by way of indication in FIG. 5 that the claw formations 318, 320 and 324, 326, 328 are each covered with a rubber coating 354 and 356. In the base element 376a there can be seen between the claws 324 and 328 a through-bore 378 which is provided, for example, in order, on assembly of the torque transmission device 310 or on insertion of the intermediate part 376 into one of the transmission parts 312, 314, to allow air enclosed between the transmission parts 312, 314 and the intermediate element 376 to escape and thus bring the intermediate element 376 into contact with the associated transmission part 312, 314.

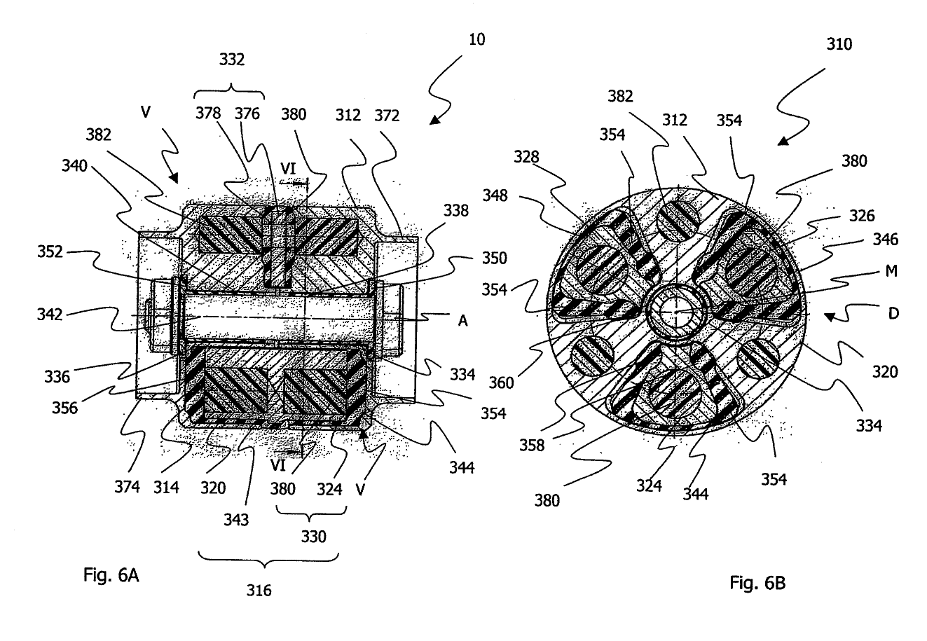

In FIGS. 6A and 6B the torque transmission device 310 is shown in each case in sectional views. FIG. 6A shows an axis-containing longitudinal section along the longitudinal axis A, whereas FIG. 6B shows an axially orthogonal section through the torque transmission device 310 along the section line VI-VI from FIG. 6a.

From FIG. 6A the intermediate element 376 and also the claws 320 and 324 protruding from the base element 376a can be seen. The claw 320 is received in the receiving opening 343 of the transmission part 314 and the claw 324 is received in the receiving opening 344 of the transmission part 312. In other words, the claw formations 318, 320 and 324, 328 are each received in the receiving areas 330 of the transmission part 312 and in the receiving area 332 of the transmission part 314. This is evident in particular from comparative viewing of the two FIGS. 6A and 6B.

It can further be seen from FIG. 6A that the disc-shaped base element 376a of the intermediate element 376 is covered with a rubber coating 380 and also serves for guidance of the transmission parts 312 and 314 in their circumferential region. The base element 376a further limits a tilting angle of the two transmission parts relative to one another in the operation of the torque transmission device 310.

The claws 324, 326, 328 are each covered with a rubber coating 354, having indentations 358 at the end thereof leading up to the centre axis M (FIG. 6B). Provided on the rubber coating 354 in the region of the indentations 358 are bulging thickenings 360 which fill the indentations 558 and project in the direction of the side walls of the receiving opening 344, 346 and 348.

Besides the above-described intermediate element 376, there is a further difference from the above embodiments according to FIGS. 1 to 3 in that elastomer bodies 380, 382 are provided both in the claws 318, 320 and 324, 326, 328 and in the transmission parts. Owing to the elastomer bodies 380, 382, the behaviour of the torque transmission device 310 can be better adjusted to specific frequencies of vibrations and oscillations which arise in a drive train of a motor vehicle.

The functioning of the torque transmission device 310 according to the fourth embodiment corresponds more or less to the functioning of the embodiments described with reference to FIGS. 1 to 3, with the difference that the torque to be transmitted is not transmitted directly via the transmission parts 312 and 314, but via an interposed intermediate element 376. A torque is introduced into the torque transmission device 310, for example, via the transmission part 312, whereupon the transmission part 312 is displaced with compression of the damping coating 354 in the direction of the intermediate element 376 relatively about axis M, i.e. the torque is transmitted with compression of the damping coating 354 by interaction of the claws 324, 326, 328 with the receiving openings 344, 346, 348 to the intermediate element 376. The intermediate element 376 is displaced relatively with its claw formation 318 and 320 in the direction of the receiving openings 343 of the transmission part 314, whereby the torque is transmitted to the transmission part 314. The transmission part 314 thus driven now in turn drives the shaft section (not shown) connected to it in a rotationally fixed manner.

What is claimed is:

1. Device for the vibration-reduced transmission of torques between two shaft sections in a shaft arrangement comprising two transmission parts that interact in a torque-transmitting manner in a coupling area, wherein each of the transmission parts has a protruding claw formation, which is received in a receiving area for the transmission of torque from the respectively other transmission part, wherein a damping device is provided between the transmission parts, wherein each of the transmission parts also has a closed bearing ring with a bearing opening, which receives and supports an axial positioning pin, and wherein the bearing ring is integrally connected to the associated claw formation of the respective transmission part and extends axially into the receiving area.

2. Device according to claim 1, wherein the claws of the claw formation of the one transmission part are received in corresponding receiving openings in the receiving area of the other transmission part.

3. Device according to claim 2, wherein the shape of the radially inner section of the claw formation of the one transmission part is adapted to the shape of the closed bearing ring of the respectively other transmission part.

4. Device according to claim 3, wherein between the bearing rings of the transmission parts there is provided on the positioning pin a positioning sleeve, which is arranged at the outer circumference of the torque transmission device between the transmission parts of a slide bush.

5. Device according to claim 1, wherein the transmission parts are supported on the positioning pin by means of bearing bushes which are adapted to the length of the bearing rings of the transmission parts.

6. Device according to claim 1, wherein the transmission parts are axially braceable by means of the positioning pin.

7. Device according to claim 1, wherein the damping device has at least two damping material coatings, in particular rubber coatings, in each case one damping material coating surrounding the claw formation and the receiving portion of a transmission part.

8. Device according to claim 1, wherein the claw formations and the receiving areas have indentations at their end running in the direction of the centre axis and in that the damping material coating has a bulging thickening in the region of the indentations of the claws.

9. Device according to claim 1, wherein the claw formation of at least one of the transmission parts is at least partially covered with a first material, the vibration-reducing damping device between the claw formations of the two transmission parts being made of a second material.

10. Device according to claim 9, wherein the claw formations of the transmission parts are at least partially covered with plastic, as the first material.

11. Device according to claim 9, wherein two transmission parts are substantially uniformly designed at least in the coupling area.

12. Device according to claim 9, wherein the damping device has at least one damping coating made of the second material between the claw formations of the transmission parts, which claw formations can be brought into engagement with one another and are covered with the first material.

13. Device according to claim 12, wherein each of the claw formations of the transmission parts covered with the first material has in each case a damping material coating.

14. Device according to claim 12, wherein the at least one damping coating made of the second material is provided with insert parts.

15. Device according to claim 1, wherein the coverings of the claw formations made of the first material have indentations at their end running in the direction of the centre axis and in that the damping coating made of the second material has a bulging thickening in the region of the indentations of the coverings made of the first material.

16. Device according to claim 1, wherein between the transmission parts there is provided a positioning pin, by means of which the device is axially braceable.

17. Device according to claim 1, wherein between the transmission parts a central positioning sleeve is provided on the positioning pin.

18. Device according to claim 1, wherein each of the transmission parts has a closed bearing ring with a bearing opening, which receives and supports the axial positioning pin, wherein the bearing ring is integrally connected to the associated claw formation of the respective transmission part and extends axially into a receiving area of the transmission parts.

19. Device according to claim 18, wherein the claws of the one transmission part are received in corresponding receiving openings in the receiving area of the respectively other transmission part.

20. Device for the vibration-reduced transmission of torques between two shaft sections in a shaft arrangement comprising two transmission parts that interact in a torque-transmitting manner in a coupling area, wherein each of the transmission parts has a receiving area, in which at least one protruding claw formations of an intermediate element engages for the transmission of torque, wherein a damping device is provided between the transmission parts and the intermediate element, wherein each of the transmission parts also has a closed bearing ring with a bearing opening, which receives and supports an axial positioning pin, and wherein the bearing ring is integrally connected to the associated claw formation of the respective transmission part and extends axially into the receiving area.

21. Device according to claim 20, wherein the intermediate element has a disc-shaped base element, from which claw formations protrude on both sides in the axial direction.

22. Device according to claim 20, wherein the claw formations and the transmission parts are at least partially filled with an elastomer.

23. Device according to claim 20, wherein the claws of the claw formations of the intermediate element are received in corresponding receiving openings in the receiving area of one of the transmission part.

24. Shaft arrangement having a device according to claim 1.

25. Shaft arrangement having a device according to claim 20.
